(19) United States
(12) Patent Application Publication
(10) Pub. No.: US 2017/0241491 A1
(43) Pub. Date: Aug. 24, 2017

(54) FLEXPLATE ASSEMBLY AND SYSTEMS INCORPORATING THE SAME

(71) Applicant: BorgWarner Inc., Auburn Hills, MI (US)

(72) Inventors: Brett M. PEGLOWSKI, Oakland, MI (US); Keith MARTIN, Marlette, MI (US)

(21) Appl. No.: 15/501,610

(22) PCT Filed: Aug. 6, 2015
(86) PCT No.: PCT/US2015/044026

§ 371 Date: Feb. 3, 2017

Related U.S. Application Data
(63) Continuation-in-part of application No. 14/453,971, filed on Aug. 7, 2014, now abandoned.

(51) Int. Cl. F16D 41/066; F02N 11/08; F16F 15/30

(52) U.S. Cl. CPC F16D 41/066; F16F 15/30; F02N 11/0848

(57) ABSTRACT

A flexplate assembly (26) for use in a starting system (31) for translating rotational torque between an engine and a transmission includes a drive assembly (28) adapted to be attached to the engine and the transmission for translating rotational torque therebetween. The flexplate assembly (26) also includes a ring assembly (30) having a ring gear (32) adapted to permanently engage a pinion gear (24) of a starter motor (22) of the starting system (31). The ring assembly (30) rotates with the drive assembly (28) in response to rotational torque generated by the pinion gear (24) of the starter motor (22). The drive assembly (28) disengages from the ring assembly (30) in response to rotational torque generated by the engine.

### CROSS-REFERENCE TO RELATED APPLICATION(S)

The present application claims priority to and all the benefits of U.S. patent application Ser. No. 14/453,971, filed on Aug. 7, 2014, which is hereby expressly incorporated herein by reference in its entirety.

### BACKGROUND OF INVENTION

### 1. Field of Invention

The present invention relates, generally, to powertrain systems and, more specifically, to a flexplate assembly and systems incorporating the same.

### 2. Description of the Related Art

Conventional automotive powertrain systems known in the art typically include an internal combustion engine and a transmission. The engine generates rotational torque through a crankshaft which is typically an input to the transmission. In some systems, a ring gear may be disposed between the engine and transmission. Depending on the type of transmission, the ring gear may be integrated on a clutch flywheel, a flexplate to which a torque converter or modular clutch assembly is attached, or on any powertrain component that rotates with the crankshaft. The ring gear cooperates with a rotatable pinion gear of a starter motor to rotate the engine at startup. In some starter systems, the starter motors tend to rotate the pinion gear and then move the pinion gear axially into engagement with the ring gear, creating a distinctive noise as teeth of the rotating pinion gear engage teeth of the ring gear.

So-called “permanently engaged” starter systems are also known in the art, wherein the pinion gear of the starter motor does not move axially and is always engaged with the ring gear. In this starter system, a one-way clutch is engaged the moment the ring gear is rotated by the pinion gear to start the engine and, when the starter motor is stopped, the one-way clutch freewheels and the ring gear stops, which may generate noise and reduce the efficiency of the engine.

Each of the components of a starting system of the type described above must cooperate to effectively start the engine. In addition, each of the components must be designed not only to facilitate improved performance and efficiency, but also so as to reduce the cost and complexity of manufacturing and assembling the starting system. While starting systems known in the related art have generally performed well for their intended purpose, there remains a need in the art for a starting system that has superior operational characteristics, and, at the same time, reduces the cost and complexity of manufacturing the components of the system, as well as the amount of noise generated in operation.

### SUMMARY OF THE INVENTION

The present invention overcomes the disadvantages in the related art in a flexplate assembly for use in a staring system for translating rotational torque between an engine and a transmission. The flexplate assembly includes a drive assembly adapted to be attached to the engine and the transmission for translating rotational torque therebetween. The flexplate assembly also includes a ring assembly having a ring gear adapted to permanently engage a rotatable pinion gear of a starter motor of the starting system. The ring assembly rotates with the drive assembly in response to rotational torque generated by the pinion gear of the starter motor, and the drive assembly disengages from the ring assembly in response to rotational torque generated by the engine.

In addition, the present invention is directed toward a starting system for use in starting an engine for translating rotational torque between the engine and a transmission. The starting system includes a starter motor adapted to be attached to one of the engine and the transmission. The starter motor has a rotatable pinion gear. The starting system also includes a drive assembly adapted to be attached to the engine and the transmission for translating rotational torque therebetween. The starting system further includes a ring assembly having a ring gear permanently engaging the pinion gear of the starter motor. The ring assembly rotates with the drive assembly in response to rotational torque generated by the pinion gear of the starter motor, and the drive assembly disengages from the ring assembly in response to rotational torque generated by the engine.

Further, the present invention is directed toward a method of starting an engine operatively attached to a transmission. The method includes the steps of providing an engine control unit and providing a starter motor operatively attached to at least one of the engine and the transmission and in communication with the engine control unit. The starter motor has a rotatable pinion gear. The method also includes the steps of providing a flexplate assembly disposed between the engine and the transmission. The flexplate assembly includes a drive assembly operatively attached to the engine and the transmission for translating rotational torque therebetween, and a ring assembly having a ring gear permanently engaging the pinion gear of the starter motor. The ring assembly is in selective rotational movement with the drive assembly, and the flexplate assembly is movable between a freewheel configuration and a locked configuration in response to a predetermined rotational torque differential occurring between the drive assembly and the ring assembly. The method further includes the steps of activating the starter motor by the engine control unit, rotating the pinion gear by the starter motor and translating rotational torque to the ring gear of the drive assembly thereby causing the flexplate assembly to move to the locked configuration to rotate the crankshaft of the engine, detecting a rotational speed of the engine with the engine control unit, de-activating the starter motor by the engine control unit in response to the engine reaching a predetermined rotational speed, and generating rotational torque with the crankshaft of the engine such that the flexplate assembly moves to the freewheel configuration in response to a predetermined rotational torque differential occurring between the ring assembly and the drive assembly.

In this way, the present invention significantly reduces the complexity, noise generation, and packaging size of the starting system and its associated components. Moreover, the present invention reduces the cost of manufacturing starting systems that have superior operational characteristics, such as improved engine performance, control, and efficiency.

### BRIEF DESCRIPTION OF THE DRAWINGS

Other objects, features, and advantages of the present invention will be readily appreciated as the same becomes better understood after reading the subsequent description taken in connection with the accompanying drawings.

FIG. 1 is a partial perspective view of a flexplate assembly, according to one embodiment of the present invention.

FIG. 2 is a partial exploded perspective view showing a starter motor, crankshaft, torque converter, and the flexplate assembly of FIG. 1.

FIG. 3 is an enlarged perspective view of the flexplate assembly of FIGS. 1 and 2.

FIG. 4 is an exploded perspective view of the flexplate assembly of FIG. 3 illustrating a drive assembly and a ring assembly.

FIG. 5 is an enlarged perspective view of one portion of the drive assembly of FIG. 4.

FIG. 6 is an enlarged perspective view of another portion of the drive assembly of FIG. 4.

FIG. 7A is a cross-sectional view of the flexplate assembly of FIG. 3.

FIG. 7B is an enlarged view taken from circle 7B of FIG. 7A.

### DETAILED DESCRIPTION OF THE INVENTION

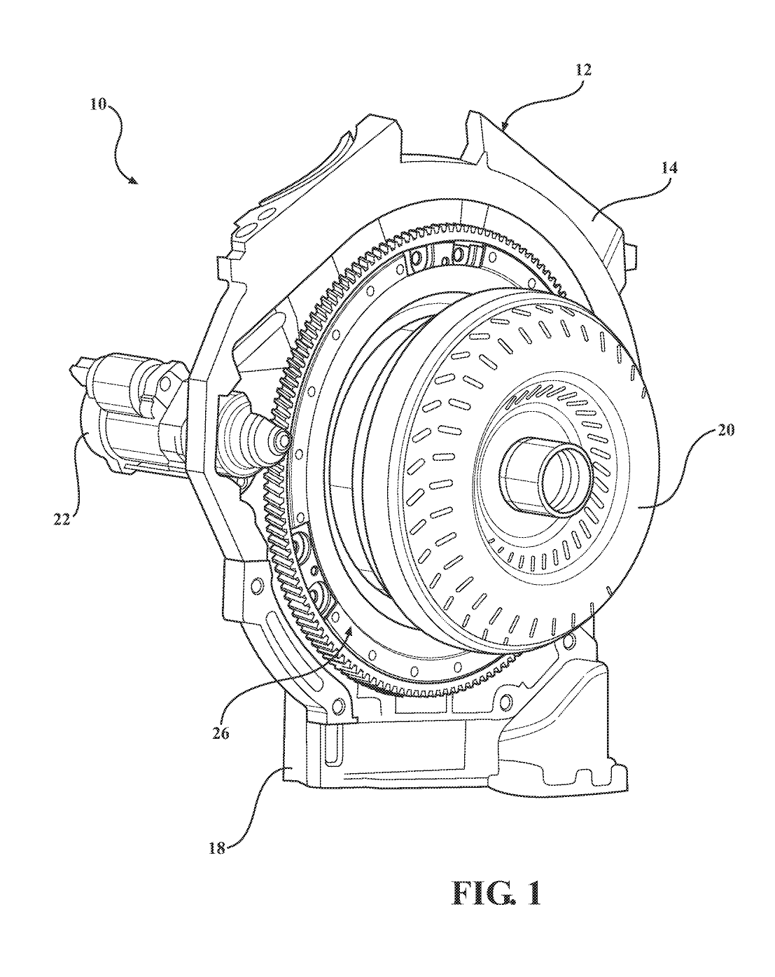

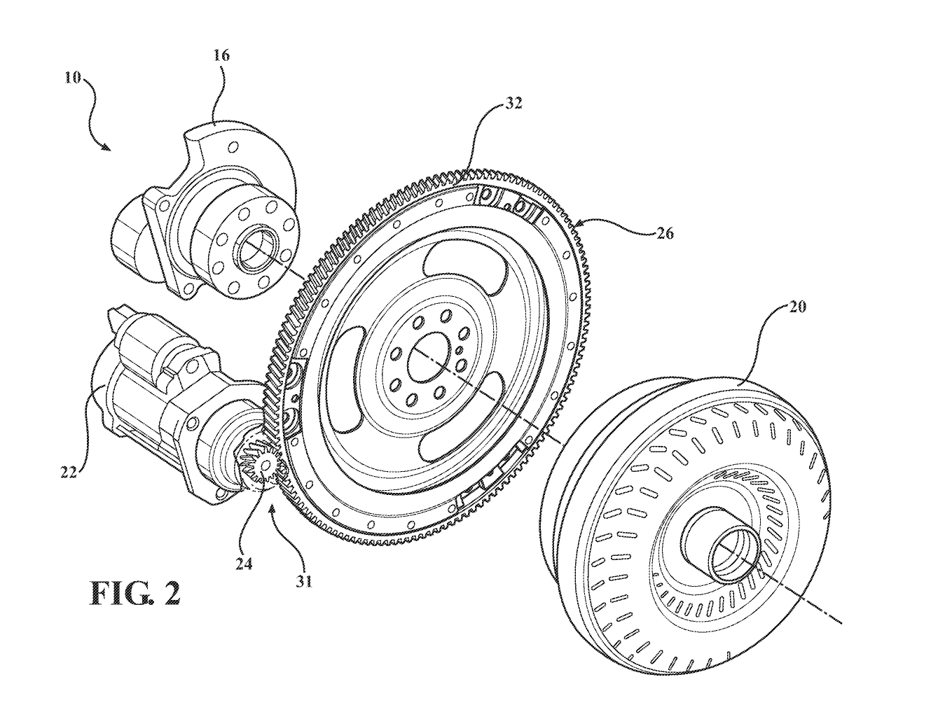

Referring now to the figures, where like numerals are used to designate like structure, a portion of a powertrain system 10 of a vehicle such as an automotive vehicle is illustrated in FIGS. 1 and 2. The powertrain system 10 includes an internal combustion engine 12 (partially shown) operatively attached to a transmission (partially shown). The engine 12 is adapted to generate and translate rotational torque to the transmission and includes a block 14 and a crankshaft 16 (see FIG. 2) rotatably supported in the block 14. The engine 12 also typically includes an oil pan 18 attached to the block 14. While in one embodiment the engine 12 is a V-configured, dual-overhead-cam (DOHC), spark-ignition Otto-cycle engine, those having ordinary skill in the art will appreciate that the engine 12 could be of any suitable configuration controlled using any suitable thermodynamic cycle without departing from the scope of the present invention.

The powertrain system 10 also typically includes a torque management member 20 rotationally cooperating with the crankshaft 16 for managing torque between the engine 12 and transmission. As shown in FIGS. 1 and 2, the torque management member 20 is a torque converter, conventionally used in conjunction with automatic transmissions as well as certain types of continuously-variable transmissions. However, those having ordinary skill in the art will appreciate that the torque management member 20 could be of any type or configuration suitable to manage torque between the engine 12 and transmission, without departing from the scope of the present invention. By way of non-limiting example, the torque management member 20 could be a clutch assembly (not shown, but generally known in the art) used in conjunction with a manual transmission. It should be appreciated that the torque management member 20 may be considered part of the transmission.

To start the engine 12, a starter motor 22 is used. As illustrated in FIG. 2, and according to one embodiment of the present invention, the starter motor 22 includes a rotatable pinion gear 24 that cooperates with a flexplate assembly 26 to rotate the crankshaft 16 of the engine 12 at startup. The flexplate assembly 26 is used to translate rotational torque between the starter motor 22, the engine 12, and the transmission. More specifically, and as illustrated in FIGS. 1 and 2, the flexplate assembly 26 is operatively attached to the crankshaft 16 and the torque management member 20 and is used to translate rotational torque therebetween so as to manage or control torque between the engine 12 and the transmission. However, those having ordinary skill in the art will appreciate that the engine 12 can be used to translate rotational torque to any suitable type of input and, thus, the flexplate assembly 26 of the present invention can be used in conjunction with the engine 12 irrespective of the presence of a transmission and/or a torque management member 20. Further, it will be appreciated that neither the engine 12 nor the transmission form a part of the flexplate assembly 26 of the present invention, and are described herein for the purpose of clarity and as an example of one use of the flexplate assembly 26 in the method described in greater detail below.

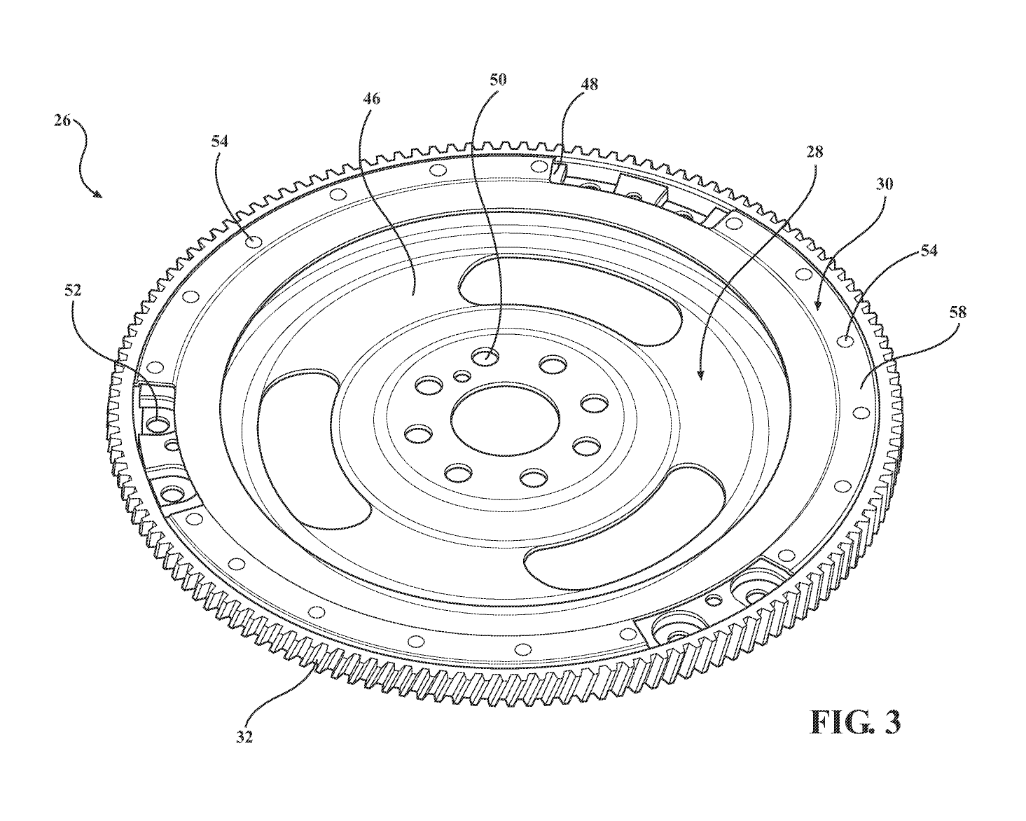

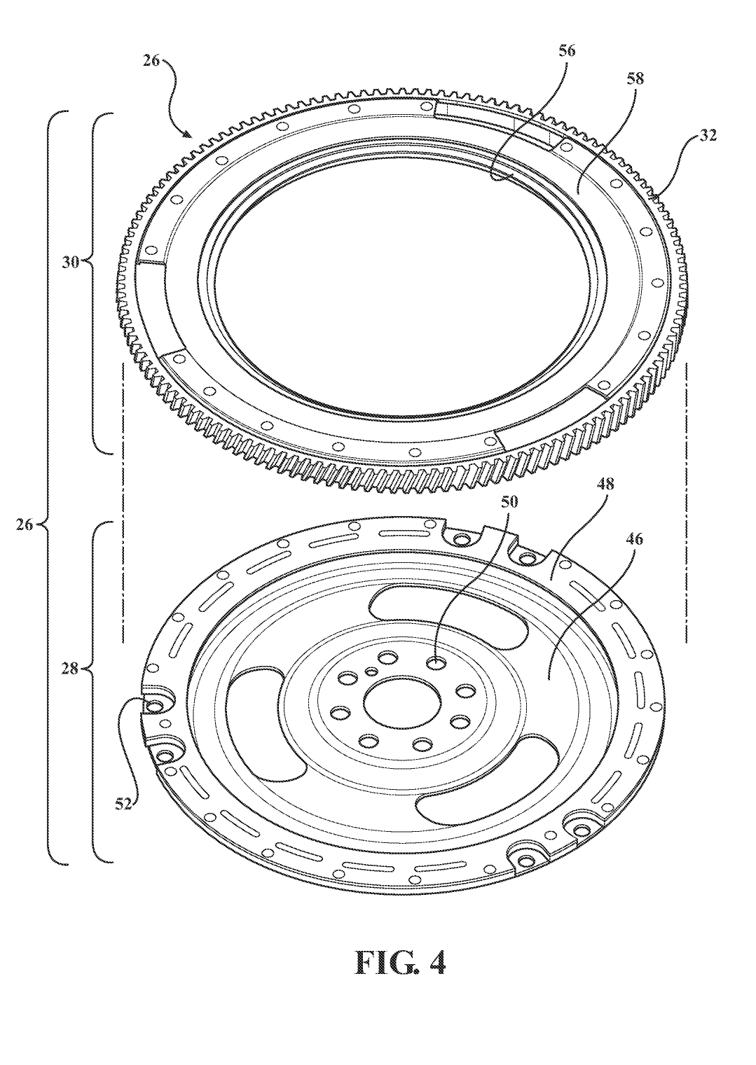

Referring now to FIGS. 1-4, the flexplate assembly 26 includes a drive assembly 28 and a ring assembly 30. In one embodiment, the drive assembly 28, ring assembly 30, and starter motor 22 define a starting system 31 for translating rotational torque between the engine 12 and transmission. More specifically, the drive assembly 28 is operatively attached to the engine 12 and the transmission for translating rotational torque therebetween. As illustrated in FIG. 2, the drive assembly 28 is concentrically aligned with and operatively attached to both the crankshaft 16 and the torque management member 20. The ring assembly 30 includes a ring gear 32 permanently engaging the pinion gear 24 of the starter motor 22 (see FIG. 2). The ring assembly 30 cooperates with the drive assembly 28 such that the ring assembly 30 rotates with the drive assembly 28 in response to rotational torque generated by the pinion gear 24 of the starter motor 22, and the drive assembly 28 disengages from the ring assembly 30 in response to rotational torque generated by the engine 12. The drive assembly 28 and ring assembly 30 will be described in greater detail below.

As noted above, the starting system 31 enables the starter motor 22 to be permanently engaged with the flexplate assembly 26, whereby the pinion gear 24 of the starter motor 22 is permanently meshed with the ring gear 32 of the ring assembly 30 of the flexplate assembly 26. In one embodiment, the pinion gear 24 and ring gear 32 have helical teeth that are spaced diagonally with respect to gear rotation, which improves tooth-to-tooth engagement and thereby allows flexibility with respect to the design, spacing, size, and orientation of the teeth of the ring gear 32 and the pinion gear 24. Moreover, the helical profiles of the teeth of the ring gear 32 and pinion gear 24 significantly reduces noise generation, thus enabling the engine 12 to be started quietly, which also contributes to an improved start-stop driving experience. Further, as will be appreciated from the description of the drive assembly 28 and ring assembly 30 below, the relationship between the pinion gear 24 of the starter motor 22 and the ring gear 32 of the flexplate assembly 26 enables improved flexibility in the design, sizing, and orientation of the starter motor 22 and the flexplate assembly 26, whereby the overall weight and packaging size of the starting system 31 can be reduced. It should be appreciated that the teeth of the pinion gear 24 and ring gear 32 may be straight or linear.

In operation, helical gear thrust load is translated in one direction from the helical teeth of the pinion gear 24 to the helical teeth of the ring gear 32 toward the engine 12. A reaction force from the resisted thrust at the crankshaft 16 is translated in the opposite direction through the inner race 56 of the ring assembly 30 to the block 14 of the engine 12 and is grounded out. It should be appreciated that the gear thrust and reaction force keeps the alignment of the flexplate assembly 26 square and not skewed, resulting in quiet operation of the starter system 31.

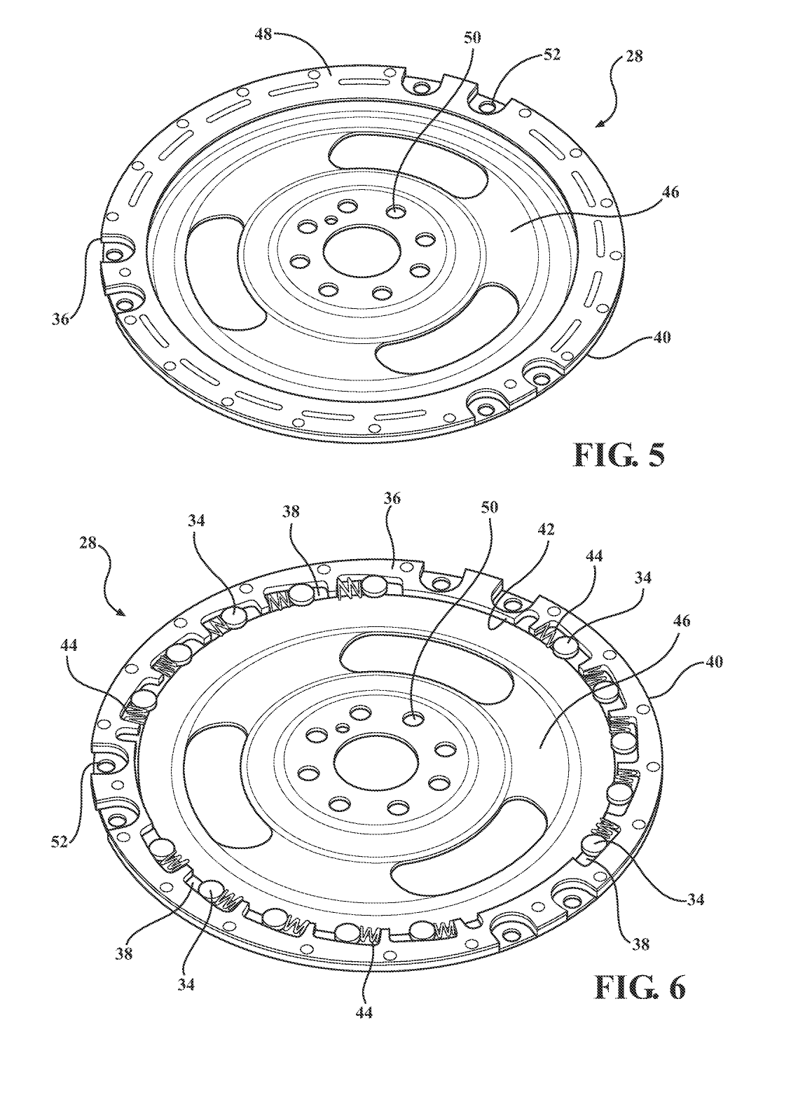

As illustrated in FIG. 6, in one embodiment, the drive assembly 28 includes a plurality of radially-spaced rollers 34 at least partially engaging the ring assembly 30. The rollers 34 are used to translate rotational movement between the drive assembly 28 and the ring assembly 30. In one embodiment, the rollers 34 have a substantially cylindrical shape. However, those having ordinary skill in the art will appreciate that the rollers 34 could have any shape or be of any type or configuration suitable to translate rotational movement between the drive assembly 28 and the ring assembly 30 without departing from the scope of the present invention. Moreover, it will be appreciated that the rollers 34 could be omitted from the flexplate assembly 26 without departing from the scope of the present invention.

Referring now to FIGS. 5 and 6, in one embodiment, the drive assembly 28 includes an interface ring 36 spaced from the engine 12 and transmission. The interface ring 36 has a plurality of radially-spaced apertures 38 defined therein, with the rollers 34 at least partially disposed in and moveable along the apertures 38. As illustrated in the embodiment in FIG. 6, the interface ring 36 includes ten apertures 38 and a corresponding ten rollers 34. However, those having ordinary skill in the art will appreciate that any suitable number of apertures 38 and/or rollers 34 could be used without departing from the scope of the present invention. In one embodiment, the interface ring 36 has an outer portion 40 and an inner portion 42, with the apertures 38 defined along and merging with the inner portion 42, whereby the rollers 34 extend beyond the inner portion 42 (see FIG. 6) and interact with the ring assembly 30 as described in greater detail below. However, those having ordinary skill in the art will appreciate that the rollers 34 could be disposed in any suitable location with respect to the interface ring 36 without departing from the scope of the present invention. Further, in one embodiment, the apertures 38 have a tapered profile such that the rollers 34 move radially inwardly with respect to the inner portion 42 of the interface ring 36 as the rollers 34 move along said apertures 38. It should be appreciated that the apertures 38 could have any suitable profile without departing from the scope of the present invention. It should also be appreciated that the rollers 34 act as a one way clutch or engagement function.

As noted above, the rollers 34 interact with the ring assembly 30 so as to effect rotational movement of the flexplate assembly 26. To that end, and in one embodiment, the drive assembly 28 may include a plurality of springs 44 disposed in the apertures 38 and at least partially engaging the rollers 34 for biasing the rollers 34 within the apertures 38. As illustrated in the embodiment in FIG. 6, the springs 44 are compression coil springs 44. However, those having ordinary skill in the art will appreciate that any spring 44 of any suitable type or configuration could be utilized without departing from the scope of the present invention. Further, it will be appreciated that the springs 44 could be either partially or entirely omitted without departing from the scope of the present invention. To that end, it is conceivable that the rollers 34 could be configured to move along and within the apertures 38 of the interface ring 36 without the use of springs 44, whereby rotational inertia and/or centrifugal force moves the rollers 34 into engagement with the ring assembly 30 in operation. Moreover, it is conceivable that less than all of the rollers 34 could have corresponding springs 44. Similarly, it should be appreciated that springs 44 having different properties from one another could be utilized. By way of non-limiting example, one or more springs 44 in the same flexplate assembly 26 could have different spring rates, free lengths, solid lengths, cross-sectional profiles, wire sizes, rate profiles, frequency profiles, etc. without departing from the scope of the present invention. Similarly, the springs 44 could have different materials, processing, heat treatment, etc. from one another without departing from the scope of the present invention. Thus, it will be appreciated that one or more of the springs 44 could be substituted, omitted, or otherwise changed depending on the specific requirements of the application of the flexplate assembly 26 as long as one-way clutch or engagement function is maintained.

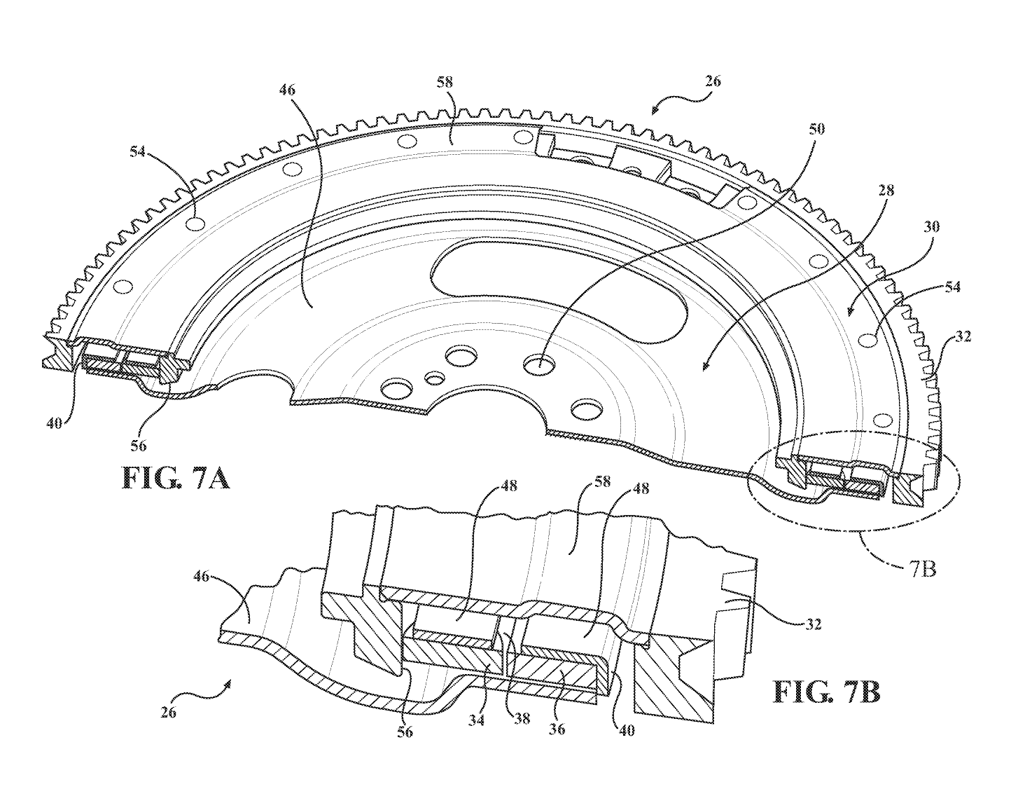

In one embodiment illustrated in FIGS. 5-7B, the drive assembly 28 includes a drive plate 46 and a retaining plate 48. The drive plate 46 is operatively attached to the engine 12 and the transmission. As shown in FIGS. 5 and 6, the drive plate 46 may include a plurality of radially-spaced inner holes 50 and outer holes 52, for attaching to the crankshaft 16 and the torque management member 20, respectively. However, it will be appreciated that the drive plate 46 could be operatively attached to the crankshaft 16 of the engine 12 and the torque management member 20 of the transmission in different ways without departing from the scope of the present invention. Similarly, while the retaining plate 48 is operatively attached to the drive plate 46 with a plurality of radially-spaced rivets 54, it will be appreciated that the retraining plate 48 could be operatively attached to the drive plate 46 in any suitable way without departing from the scope of the present invention. Further, at least one of the interface ring 36 and the rollers 34 are at least partially disposed between the drive plate 46 and the retaining plate 48 (see FIG. 7B).

In one embodiment, and as illustrated in FIGS. 7A-7B, the ring assembly 30 further includes an inner race 56 and a shell 58. The inner race 56 engages the rollers 34 of the drive assembly 28, as described above, and the shell 58 extends between and merges with the inner race 56 and the ring gear 32. While the inner race 56, shell 58, and ring gear 32 are operatively attached to one another by welding, those having ordinary skill in the art will appreciate that any suitable type of attachment could be utilized, for example sprags, etc., without departing from the scope of the present invention as long as one-way clutch or engagement function is maintained.

As noted above, the present invention is also directed toward a method of starting an engine 12 in a vehicle (not shown, but generally known in the art) operatively attached to a transmission. The method includes the steps of providing an engine control unit and providing a starter motor 22 operatively attached to at least one of the engine 12 and the transmission and communicating with the engine control unit. The starter motor 22 has a rotatable pinion gear 24. The method also includes the steps of providing a flexplate assembly 26 disposed between the engine 12 and the transmission. The flexplate assembly 26 includes a drive assembly 28 operatively attached to the engine 12 and the transmission for translating rotational torque therebetween, and a ring assembly 30 having a ring gear 32 permanently engaging the pinion gear 24 of the starter motor 22. The ring assembly 30 is in selective rotational movement with the drive assembly 28. The flexplate assembly 26 is movable between a freewheel configuration and a locked configuration in response to a predetermined rotational torque differential occurring between the drive assembly 28 and the ring assembly 30. The method further includes the steps of activating the starter motor 22 by the engine control unit, rotating the pinion gear 24 and translating rotational torque to the ring gear 32 of the drive assembly 28 thereby causing the flexplate assembly 26 to move to the locked configuration to rotate the crankshaft 16 of the engine 12, detecting a rotational speed of the engine 12 with the engine control unit, de-activating the starter motor 22, by the engine control unit, in response to the engine 12 reaching a predetermined rotational speed, and generating rotational torque such that the flexplate assembly 26 moves to the freewheel configuration in response to a predetermined rotational torque differential occurring between the ring assembly 30 and the drive assembly 28.

In one embodiment, the method described above includes the further steps of providing the pinion gear 24 and the ring gear 32 with helical teeth. The method may include the steps of driving the vehicle using rotational torque generated by the engine 12 and translated through the flexplate assembly 26 to the transmission, and stopping rotation of the crankshaft 32 of the engine 12 in response to the vehicle reaching a predetermined speed.

In this way, the present invention significantly reduces the complexity, cost, and packaging size of powertrain systems 10 and associated components. Specifically, it will be appreciated that the present invention provides significant advantages relating to elimination of noise, vibration, and harshness (NVH) traditionally associated with conventional starting systems. To that end, the ring gear 32 of the flexplate assembly 26 and the pinion gear 24 of the starter motor 22 cooperate to provide smooth, consistent, and quiet meshing of teeth so as to start the engine 12. Moreover, it will be appreciated that the flexplate assembly 26 and starting system 31 of the present invention can be used in conjunction with any suitable type of powertrain system 10, irrespective of the type of transmission or lubrication used. Further still, the present invention reduces the cost of manufacturing starting systems 31 and components that have superior operational characteristics, such as improved performance, weight, component life and longevity, and efficiency.

The present invention has been described in an illustrative manner. It is to be understood that the terminology which has been used is intended to be in the nature of words of description rather than of limitation.

Many modifications and variations of the invention are possible in light of the above teachings. Therefore, within the scope of the appended claims, the invention may be practiced other than as specifically described.

1. A flexplate assembly (26) for use in a starting system (31) for translating rotational torque between an engine and a transmission, said flexplate assembly (26) comprising:
a drive assembly (28) adapted to be attached to the engine and the transmission for translating rotational torque therebetween; and
a ring assembly (30) having a ring gear (32) adapted to permanently engage a rotatable pinion gear (24) of a starter motor (22) of the starting system (31), said ring assembly (30) rotating with said drive assembly (28) in response to rotational torque generated by the pinion gear (24) of the starter motor (22), and said drive assembly (28) disengaging from said ring assembly (30) in response to rotational torque generated by the engine, wherein said ring gear (32) has helical teeth adapted to engage helical teeth of the pinion gear (24).

2. (canceled)

3. The flexplate assembly (26) as set forth in claim 1, wherein a helical gear thrust load is translated in one direction from said helical teeth of said pinion gear (24) to said helical teeth of said ring gear (32) toward the engine and a reaction force is adapted to be translated in an opposite direction through said ring assembly (30) to the engine.

4. The flexplate assembly (26) as set forth in claim 1, wherein said drive assembly (28) includes a plurality of radially-spaced rollers (34) at least partially engaging said ring assembly (30) for translating rotational movement between said drive assembly (28) and said ring assembly (30).

5. The flexplate assembly (26) as set forth in claim 4, wherein said drive assembly (28) further includes an interface ring (36) spaced from the engine and the transmission, said interface ring (36) having a plurality of radially-spaced apertures (38) defined therein with said rollers (34) at least partially disposed in and movable along said apertures (38).

6. The flexplate assembly (26) as set forth in claim 5, wherein said interface ring (36) has an outer portion (40) and an inner portion (42) with said apertures (38) defined along and merging with said inner portion (42).

7. The flexplate assembly (26) as set forth in claim 6, wherein said apertures (38) have a tapered profile such that said rollers (34) move radially inwardly with respect to said inner portion (42) of said interface ring (36) as said rollers (34) move along said apertures (38).

8. The flexplate assembly (26) as set forth in claim 5, wherein said drive assembly (28) further includes a plurality of springs (44) disposed in said apertures (38) and at least partially engaging said rollers (34) for biasing said rollers (34) within said apertures (38).

9. The flexplate assembly (26) as set forth in claim 5, wherein said drive assembly (28) further includes:
a drive plate (46) adapted to be attached to the engine and the transmission; and
a retaining plate (48) operatively attached to said drive plate (46) with at least one of said interface ring (36) and said rollers (34) being least partially disposed between said drive plate (46) and said retaining plate (48).

10. The flexplate assembly (26) as set forth in claim 4, wherein said ring assembly (30) further includes:
an inner race (56) for engaging said rollers (34) of said drive assembly (28); and
a shell (58) extending between and merging with said inner race (56) and said ring gear (32).

11. A starting system (31) for use in starting an engine for translating rotational torque between the engine and a transmission, said starting system (31) comprising:
a starter motor (22) adapted to be attached to at least one of the engine and the transmission, said starter motor (22) having a rotatable pinion gear (24);
a drive assembly (28) adapted to be attached to the engine and the transmission for translating rotational torque therebetween; and
a ring assembly (30) having a ring gear (32) permanently engaging said pinion gear (24) of said starter motor (22), said ring assembly (30) rotating with said drive assembly (28) in response to rotational torque generated by said pinion gear (24) of said starter motor (22), and said drive assembly (28) disengaging from said ring assembly (30) in response to rotational torque generated by the engine, wherein said pinion gear (24) and said ring gear (32) have helical teeth to engage each other.

12. (canceled)

13. The starting system (31) as set forth in claim 11, wherein said drive assembly (28) includes a plurality of radially-spaced rollers (34) at least partially engaging said ring assembly (30) for translating rotational movement between said drive assembly (28) and said ring assembly (30).

14. The starting system (31) as set forth in claim 13, wherein said drive assembly (28) further includes an interface ring (36) spaced from the engine and the transmission, said interface ring (36) having a plurality of radially-spaced apertures (38) defined therein with said rollers (34) at least partially disposed in and movable along said apertures (38).

15. The starting system (31) as set forth in claim 14, wherein said interface ring (36) has an outer portion (40) and an inner portion (42) with said apertures (38) defined along and merging with said inner portion (42).

16. The starting system (31) as set forth in claim 15, wherein said apertures (38) have a tapered profile such that said rollers (34) move radially inwardly with respect to said inner portion (42) of said interface ring (36) as said rollers (34) move along said apertures (38).

17. The starting system (31) as set forth in claim 14, wherein said drive assembly (28) further includes a plurality of springs (44) disposed in said apertures (38) and at least partially engaging said rollers (34) for biasing said rollers (34) within said apertures (38).

18. The starting system (31) as set forth in claim 14, wherein said drive assembly (28) further includes:
a drive plate (46) adapted to be attached to the engine and the transmission; and
a retaining plate (48) adapted to be attached to said drive plate (46) with at least one of said interface ring (36) and said rollers (34) being least partially disposed between said drive plate (46) and said retaining plate (48).

19. The starting system (31) as set forth in claim 13, wherein said ring assembly (30) further includes:
an inner race (56) for engaging said rollers (34) of said drive assembly (28); and
a shell (58) extending between and merging with said inner race (56) and said ring gear (32).

20. A method of starting and operating a vehicle having an engine operatively attached to a transmission, said method comprising the steps of:
providing an engine control unit;
providing a starter motor (22) operatively attached to at least one of the engine and the transmission and in communication with the engine control unit, the starter motor (22) having a rotatable pinion gear (24);
providing a flexplate assembly (26) disposed between the engine and the transmission, the flexplate assembly (26) including a drive assembly (28) operatively attached to the engine and the transmission for translating rotational torque therebetween, and a ring assembly (30) having a ring gear (32) permanently engaging the pinion gear (24) of the starter motor (22), the ring assembly (30) being in selective rotational movement with the drive assembly (28), and the flexplate assembly (26) being movable between a freewheel configuration and a locked configuration in response to a predetermined rotational torque differential occurring between the drive assembly (28) and the ring assembly (30);
activating the starter motor (22) by the engine control unit;
rotating the pinion gear (24) by the starter motor (22) and translating rotational torque to the ring gear (32) of the drive assembly (28) thereby causing the flexplate assembly (26) to move to the locked configuration to rotate a crankshaft (16) of the engine;
detecting a rotational speed of the engine with the engine control unit;
de-activating the starter motor (22) with the engine control unit in response to the engine reaching a predetermined rotational speed; and
generating rotational torque with the crankshaft (16) of the engine such that the flexplate assembly (26) moves to the freewheel configuration in response to a predetermined rotational torque differential occurring between the ring assembly (30) and the drive assembly (28).

21. The method as set forth in claim 20, including the further steps of providing the pinion gear (24) and the ring gear (32) with helical teeth to engage each other.
